(19) United States
(12) Patent Application Publication
(10) Pub. No.: US 2022/0180501 A1
(43) Pub. Date: Jun. 9, 2022

(54) SYSTEM AND METHOD FOR DETECTING MATERIALS

(71) Applicant: AVANGARD INNOVATIVE LP, Houston, TX (US)

(72) Inventors: Ricardo Perez, Houston, TX (US); Chung Wah Chan, Houston, TX (US); Shafiq Jadallah, Houston, TX (US)

(21) Appl. No.: 17/676,697

(22) Filed: Feb. 21, 2022

Related U.S. Application Data
(63) Continuation-in-part of application No. 16/373,021, filed on Apr. 2, 2019.
(60) Provisional application No. 62/651,491, filed on Apr. 2, 2018.

(51) Int. Cl. G06T 7/00; G06T 7/62; G06V 10/82

(52) U.S. Cl. CPC G06T 7/0004; G06T 7/62; G06T 2207/20084; G06V 10/82; G06T 7/97

(57) ABSTRACT

The present application pertains to systems and methods of detecting proper and improper material deposited into a receptacle and metrics about same. In some embodiments cameras, processors and artificial intelligence are employed so that notifications can be provided about the materials, their amounts, and various other statistics.

### CROSS-REFERENCE TO RELATED APPLICATIONS

The application is a continuation-in-part of pending U.S. application Ser. No. 16/373,021 filed Apr. 2, 2019 which application claims the benefit of, and priority to U.S. provisional patent application Ser. No. 62/651,491, filed Apr. 2, 2018. All of the aforementioned applications are fully incorporated by reference and made a part hereof.

### FIELD OF THE INVENTION

Embodiments described herein are employed for control and management of materials including waste and recyclable materials and waste and recycling material management processes. More particularly, embodiments relate to systems and processes for monitoring and/or detecting the type of material discarded at the point of entering a receptacle and/or providing a notification when improper type or types of material are discarded.

### BACKGROUND

Currently operating facilities and/or organizations are blind as to what materials are sent to landfills or other waste collection sites, as a result of their regular operations. Thus, companies are required to perform environmental/waste audits to determine what is being sent to landfills. Such audits are extremely time-consuming processes, costly and opportunity to address improper material entering landfill and/or proper management of materials is delayed. Thus, what is needed is an effective method and system for detecting what type of material is discarded at the point of entering a waste receptacle. More specifically, what is needed is a system for monitoring material deposited into a waste receptacle and determining whether it is acceptable or non-acceptable waste material and evaluating metrics surrounding same. Advantageously, the present application addresses this issue and much more as explained in further detail below.

### SUMMARY

In one embodiment the application pertains to a system comprising a receptacle with at least one opening to deposit one or more predetermined types of material. The system includes a camera positioned to view the at least one opening and a detector operably connected to the camera. The detector is configured to communicate a signal to the camera to take a photo of the at least one opening upon detection of an event (e.g., movement, pressure, RFID signal, etc.) indicating a deposit being made to the receptacle. A processor is operably linked to the camera and the processor is configured to receive a photo from the camera of a deposit being made. The processor is also configured to detect when the deposit is or is not one or more predetermined types of materials entering the waste receptacle, including whether the deposit contains some of or none of the one or more predetermined types of materials. A notification may be provided when a deposit is or is not the one or more predetermined types of material and/or the system may provide various metrics and/or data regarding the material and/or deposits.

Furthermore, currently the solid waste industry does not provide transparency, visibility, and/or trackability regarding potential solid waste stream cost savings and/or monetary gains from capturing recyclable materials. Companies without a proper method and system for discarding materials usually pay substantial amounts for waste removal services while preventing from collecting a potential additional revenue stream associated with selling the recyclable material generated by the Company's regular operations. Further, Companies without a proper method and system for discarding materials add to landfill volumes thus impacting the environment. What is needed is a system for the comprehensive management of potentially recyclable incoming material, outgoing recyclable material, and/or outgoing waste.

Some embodiments of the application include a knowledge-based platform that combines smart technology hardware and analytics. Some embodiments provide data relating to waste material and/or recyclables to operators and/or customers to assist in making business decisions through monitoring, measuring, and managing. Preferred embodiments report a single index number, that represents the percent of recyclable material actually captured from the universe of material received at a facility or by an organization may be referred to as the Capture Percentage Rate (“CPR”).

CPR provides enhanced and streamlined visibility into the recycling and waste management processes.

Embodiments of the present disclosure provide a system for material comprising a receptacle within or associated with a facility and a first imaging device positioned to view material deposited within the receptacle. The first imaging device is operably connected to a processor that is arranged to determine one or more characteristics of the deposited material based on image data received from the first imaging device.

Embodiments of the present disclosure provide a system for determining a CPR rate as defined herein. The system comprising a central server communicatively connected to an imaging device configured to monitor a receptacle for the quantity and/or type of incoming material that is or is not one or more predetermined types of material, including whether the deposit contains some of or none of the one or more predetermined types of materials, and the portion of the of the of the incoming material that that is or is not one or more predetermined types of material.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates an example of a system for monitoring a receptacle.

FIG. 2 depicts a baler according to an example embodiment.

FIG. 3 depicts a densifier according to an example embodiment.

FIG. 4 depicts a fullness sensor according to an example embodiment.

FIG. 5 shows a flowchart of an example embodiment of the disclosed system in operation.

FIG. 6 illustrates an example computing environment in which example embodiments and aspects may be implemented

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### Embodiments Relating to Detecting Material Using Object Detection

The present application pertains generally to a system for monitoring a receptacle. Receptacles that may be employed are not particularly limited and may vary depending upon the location, types of waste, and desired results. Such receptacles include, for example, balers, densifiers, trash bins, dumpsters, compactors, and the like of any size, shape, or material. Herein, the terms “receptacle,” “waste receptacle,” and “baler” are used interchangeably and include, for example, waste bins, balers, densifiers, trash bins, dumpsters, compactors, and any device, room, container of any size, shape, or material in which material can be placed in or on. If desired a series of receptacles may be employed with a single or multiple image capture devices such as cameras and the like. As used herein, “camera” refers to any image capture device capable of capturing one or more still images and/or videos.

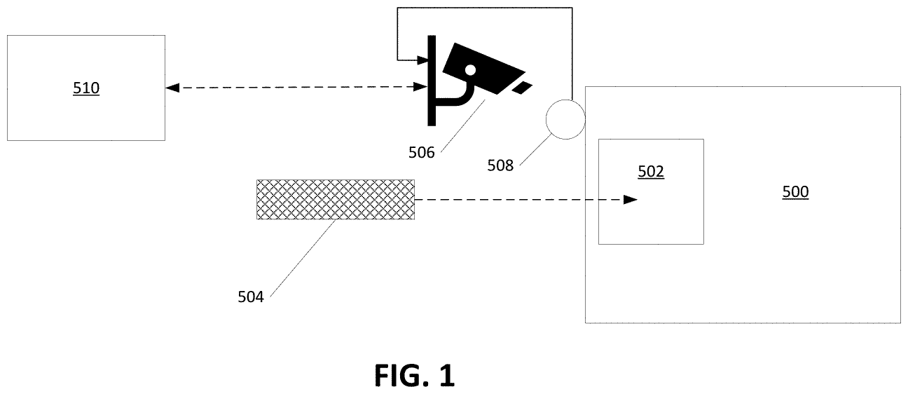

FIG. 1 illustrates a non-limiting example of a system for monitoring a receptacle 500. Typically, the receptacle 500 employed herein comprises at least one opening 502 defined by a wall, top, or bottom of the receptacle 500 to deposit materials 504. The location of the opening 502 on the receptacle 500 is not particularly critical so long as a user may deposit material 504 and an image capture device 506 such as a camera may be positioned to view the at least one opening 502 while a deposit of material 504 is being made. Thus, in some embodiments the opening 502 is on the top of the receptacle 500 while in other embodiments the opening 502 may be on the side of the receptacle 500. In some embodiments there is more than opening 502 on the receptacle 500. In some instances, one or more cameras may be used to view at least one or even all the openings 502 for depositing material 504.

An image capture device 506 such as a camera is usually positioned to view the at least one opening 502 on the receptacle 500. Thus, the camera may be mounted to the receptacle 500 (inside or outside) or remotely so long as it can view at least one opening 502. The type of camera is not particularly limited and includes any imaging device 506 capable of capturing an image (e.g., a photo) of the at least one opening 502 and/or any material 504 being placed into the receptacle 500 through the opening 502 and/or any material 504 that has already been placed in the receptacle 500 when directed to do so. The captured image may include a still photo, a series of still photos or a video. Typically, the camera employed is configured to transmit and receive both signals and data. In this manner the camera receives signals commanding it to operate from, for example, a detector 508 and may communicate photos taken to a processor 510.

Generally, the camera remains in a wait mode until some event causes it to take a photo or begin recording. In some instances, a detector 508 such as a motion detector is operably connected to the camera and configured to communicate a signal to the camera to take a photo of the at least one opening upon detection of movement indicating a deposit of material 504 being made to the receptacle 500. In some embodiments the camera and the motion detector may be integrated into the same device or instrument. The specific type of motion detector may be selected depending upon the specifics of the system, the selected environment, and desired results. Thus, various motion detectors may be employed such as passive infrared sensors, microwave sensors, dual tech or hybrid sensors, or combinations thereof. If the opening 502 to the receptacle 500 employs a cover, lid or door (not shown in FIG. 1), then a touch sensor or switch may be employed as the detector 508. Depending upon the environment an acoustic or sound sensor may be employed as the detector 508 in some instances. In other instances, a signal to the camera to take a photo based on one or more of a detector 508 comprising a pressure detector to detect a person or equipment approaching the receptable 500 and begin recording, a switch on a cover or door of the opening 502 of the receptacle 500 or attached to the receptacle 500. In other instances, equipment, persons or waste approaching the waste receptacle may be “tagged” with a smart tag or RFID tag, which is detected by the detector 508 and signals the camera to start the recording process.

In other instances, the camera may be continuously taking pictures or recording.

In most systems a processor 510 is operably linked to the camera. As used herein, “linked” may mean a wired connection (including fiber optics), a wireless connection, or combinations thereof. The processor 510 is configured to receive a photo from the camera of a deposit being made. That is, the detector 508 senses an event suggesting or indicating a deposit of material 504 is being made to the receptacle 500 and commands the camera to capture an image (including a series of photos and/or video). The camera then captures the photo and transmits it to the processor 510.

The processor 510 is configured to detect from the photo, series of photos, and/or video when the deposit of material 504 into the receptacle 500 is not or does not contain any of one or more predetermined types of materials. That is, the processor 510 is programmed with whatever the desired acceptable types of materials are, i.e., predetermined types of materials. The processor 510 executes computer-executable instructions that cause the processor to analyze the photo, series of photos and/or video comparing it to acceptable predetermined types of materials. The processor 510 then detects or determines whether the material being deposited in the photo series of photos and/or video is or is not a predetermined type of material. An exemplary computing device 600 that contains a processor 510 and that may be used in embodiments disclosed herein is shown in FIOG. 6 and described in greater detail herein.

The type of material that may be a predetermined type of material is not particularly limited. That is, in some embodiments the receptacle 500 may be for recycling cardboard in which case the only predetermined type of material that is acceptable is cardboard. Other predetermined types of material in addition to cardboard may include, for example, plastic, foam, bottles, glass, rubber, tires, metals (e.g. copper, aluminum, etc.), etc. Using the systems and method herein a user may collect information about the number, volume, weight, etc. of the acceptable, e.g., predetermined type, of material and unacceptable, e.g. not predetermined type, of material.

If desired, the processor 510 may be configured to provide notifications of when a material 504 deposited or being deposited into the receptacle 500 is not or does not contain any of the one or more of a predetermined types of material or alternatively when a material 504 deposited or being deposited into the receptacle 500 is or does contain some of the one or more of a predetermined types of material. In some embodiments the notification may be used to trigger an automatic closing of any lid, door or cover on the receptacle 500 to prevent unacceptable material from being deposited. In some embodiments the notification may be used to trigger an alarm so that an operator can intervene and perhaps prevent unacceptable material from being deposited.

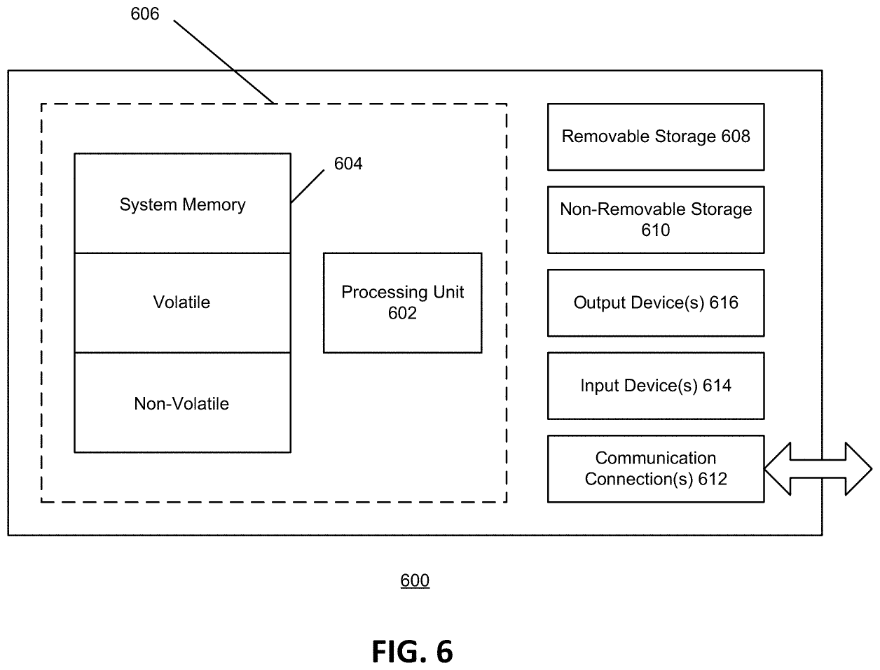

The processor 510 may be configured to support one or more additional functions, if desired. For example, the processor 510 may be in communication with a memory (see FIG. 6) configured to store photos. The memory may be integrated with and into the processor 510, or may be separate from the processor 510. Alternatively or additionally, the processor 510 may be comprise part of a cloud network and/or operably connected to a cloud database stored in the cloud network that is configured to receive the photo (including a series of photos or video). In either case if a machine learning or other artificial intelligence program, as described herein, is being used by the processor 510, then the stored photos may be used to support that function.

The processor 510 may also be configured to determine a number of different measurements that can be used for analytics and statistical analysis. For example, the processor 510 may be configured to determine one or more of the following from the photo of the material deposited and/or from a plurality of photos of materials deposited over period of time: (1) a volume or weight of total deposits that are not or do not contain any of the one or more predetermined types of material over a period of time, (2) a volume or weight of total deposits that are or do contain some of the one or more predetermined types of material over a period of time, (3) a sum of the number of deposits that are or do contain some of, or are not or do not contain any of the one or more predetermined types of material over a period of time, (4) a ratio of deposits that are not or do not contain any of the one or more predetermined types of material to the total deposits, and/or a ratio of deposits that are or do contain at least some of the one or more predetermined types of material to the total deposits .

As described above, the processor 510 may be configured to detect from the photo, series of photo, or video when a deposit is not or does not contain any of the one or more predetermined types of material and/or when the deposit is or does contain at least some of the one or more predetermined types of material. The specific manner of detection may vary depending upon the type of material(s), type of receptacle, desired accuracy, and other components of the system. In some embodiments the processor 510 may employ one or a plurality of computer vision and/or feature detection algorithms including, but not limited to a histogram of oriented gradients (HOG), integral channel features (ICF), aggregated channel features (ACF), and/or deformable part models (DPM).

In some embodiments the processor 510 may employ object detection. Such object detection may include, for example, an other region proposal classification network (RCNN), a fully convolutional neural network (FCNN), a you only look once network (YOLO), or a combination thereof. In some embodiments the accuracy of the detection using the processes and/or systems described herein may be at least about 90%, or at least about 95% based upon the total number of deposits to fill the waste receptacle.

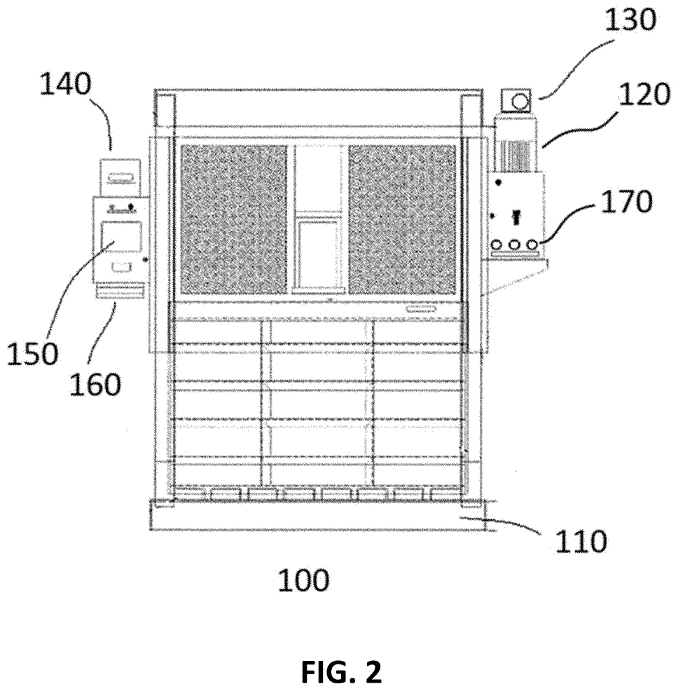

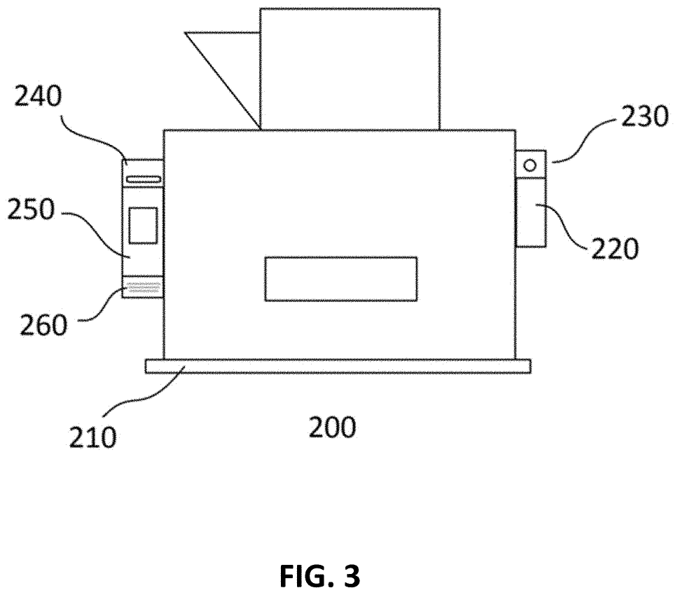

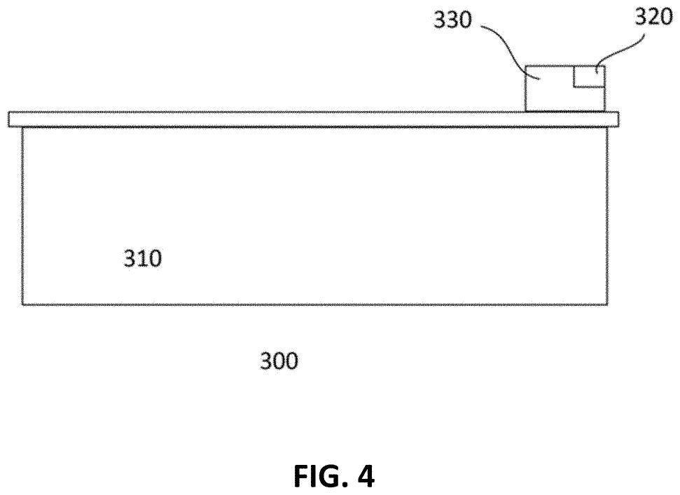

FIGS. 2, 3, and 4 show some specific embodiments of the above-described system. FIG. 2 pertains to a baler 100 as a waste receptacle. FIG. 3 pertains to a densifier 200 as a waste receptacle. FIG. 4 pertains to a general container 310 as a waste receptacle. In each of FIGS. 2-4 a camera 130, 230, and 330 is pointed to view an opening on the given waste receptacle and operably linked and connected as described above. In this specific embodiment, a motion detector is contemplated as being integrated with the camera however it should be appreciated that the motion detector may be separate from the camera. In each of FIGS. 2-4 a processor 120, 220, and 320 is operably linked and configured as described above.

In FIGS. 2-4 the detector directs the camera to take a photo when it senses an event suggesting a material deposit. The photo is transmitted to the processor from the camera where it is determined whether the deposit is an appropriate type of material.

### Predictive Modeling and Other Additional Embodiments

The present disclosure relates to systems and processes for use with receptacles including but not limited to recycling equipment, data recording devices, computer vision techniques, and predictive modeling for the management of waste streams. Components of some disclosed embodiments include, but are not limited to, balers, smart balers, smart baler retrofits, digital scales, smart scales, smart scale retrofits, imaging devices such as, for example, optical cameras, digital cameras, video cameras, or hyperspectral cameras. Other potential components include radio-frequency identification (“RFID”) and other near field readers, labels, chips, and/or printers, as well as barcode readers, labels, and/or printers. Disclosed embodiments may also comprise other hardware components used to facilitate the automated monitoring, recording, and/or tracking of material in a waste stream.

In some disclosed embodiments, image data and other data is transmitted to a processor(s) or central server(s) which may apply computer vision techniques in order to determine characteristics of a material, artificial intelligence techniques and/or predictive models to streamline a waste management process.

Some preferred embodiments provide real-time or near real-time data collected from smart balers, imaging devices, and/or scanners configured to monitor the processing of waste and recyclable material to a processor or server. Some embodiments record and analyze employee, shift, facility, and/or regional information to provide a comprehensive analysis of a waste processing operation.

When applied, disclosed embodiments may reduce the amount of solid waste sent to a landfill or incineration facility by increasing the amount of recyclable material which is monetized. The disclosed systems aim to increase percentage of all potentially recyclable material that gets recycled and, ideally, monetized. The percent of recyclable material actually captured from the universe of material received at a facility or by an organization may be referred to as the Capture Percentage Rate (“CPR”).

As a non-limiting example, a retail store may receive the goods it sells packaged in cardboard boxes. Additionally, some goods may be packaged using polystyrene, polyethylene, polypropylene, wood pulp, paper products, cloth, foam, film, bottles, glass, metal or other recyclable materials. The disclosed system helps the retail operator account for the total outgoing quantity of recyclable material that is subject to commercialization as well as outgoing streams of waste materials that are subject to disposal. Using this information, the disclosed systems are able to determine what percent of the total amount of recyclable materials that enter the store are actually being recycled and what amount are being discarded as waste. This information may be presented as a single number, the CPR.

The exemplary system provides multiple benefits to the retail operator. By presenting a retail store's CPR, the operator is able to judge how effectively it is monetizing its recyclable materials. By increasing the CPR, the operator may be able to increase revenue generated from monetizing recyclable materials and also reduce the expense associated with disposing of non-recyclable waste materials. It will be appreciated that the disclosed systems may be deployed at the individual store or facility level and may also combine information associated with multiple facilities to report a regional and/or enterprise wide CPR. It will also be appreciated that in addition to the single CPR indicator, a significant amount of underlying data and/or other key performance indicators (“KPIs”) may be recorded, reported, visualized, presented, analyzed, and/or used by the operator for a variety of purposes.

Smart Balers such as those disclosed in U.S. Patent Publication 2018/0056618, incorporated herein by reference, allow automatic data gathering from recyclable material baling devices' and/or scales via integrated processors and sensors. These devices help ensure that collected data can be used to increase material handling efficiency. This is done by reducing or eliminating the need to weigh bales via a separate floor scale, as well as eliminating human recording errors, wrong material reporting, and false data. Smart Balers may also add transparency to the measurements of traditional baler productivity, identifying which employee baled which materials, knowing when a material was baled, knowing at what location a material was baled, etc. Smart balers may include, without limitation, horizontal and vertical balers.

Traditional baling devices commonly include a large hollow space enclosed by a safety gate and a door. Recyclable material may be loaded into the empty space and compressed, frequently by the action of a piston. Some balers utilize a safety mechanism which requires the door to be locked using a door lock wheel or other mechanism prior to compressing the material in to a bale. Balers commonly have floor gaps which facilitate the insertion of baling wire under the compressed material so that the bale can be tied and completed. Balers are commonly controlled by a standard control panel which contains piston controls, a power indicator, a power disconnect, and/or a panel door lock. Smart balers may also or alternatively contain a separate or integrated smart control panel. The smart control panel may house a processor which may be operably connected to a scale, display screen, imaging device such as a camera, other sensors, and/or baler controls. Balers may be anchored in place using mounting bolts which may be arranged to orient the baler in a fixed level position. Some smart balers will provide a minimum weight indicator and a maximum weight indicator. Smart balers may also contain a separate or integrated weight display which provides the operator with the current weight of the material being baled.

Smart balers address a wide array of concerns by incorporating sensors, imaging devices, processors, and balers in order to increase the amount and reliability of data collected. The sensors detect the weight of a finished bale and, in some embodiments, the data is pushed to a cloud database. Additionally, a local processor and/or database may capture or record weight data as well as images of the product baled and the finished bale. The local processor may be attached to an input device which allows the operator to input data that may not be readily detectable by certain embodiments. The input device will commonly be a keyboard or touch pad, but a mouse, track pad, magnetic card reader, barcode scanner, RFID reader, QR reader or other input device may also be used.

Smart balers may also comprise a printer. The printer will commonly be a label printer. The label printer may print up to all known data regarding a bale and may also encapsulate this data in the form of a tracking device such as a barcode, QR Code or RFID label with an RFID chip. An operator can attach the printed label to the finished bale, thereby ensuring that an accurate record of the bale information accompanies the bale through each step of the recycling chain. In preferred embodiments, the label printer will print onto adhesive stickers so that the labels may be quickly adhered to the bales or bale wrapper without the need for an additional attachment mechanism.

The addition of a tracking device such as a barcodes, smart tags, RFID tags, etc. allows for fast and accurate inventory when bales, material, etc. are moved from facilities, trucks or other transition points in the recycling chain or possibly moved between storage areas. In some instances, embodiments described herein use an RFID or other near-field labeling technology to label material, bales, etc. with some or all of the collected data relating to the material and/or bale. This can greatly facilitate accurate inventory control and can be used to send a signal to the image capture device to captured images. In other instances, if RFID chips are used to label each bale, a truck or storage location equipped with an RFID reader can tally each bale moved into and out of the truck or storage location with minimal human involvement.

FIG. 2 illustrates a smart baler 100 according to an example embodiment. In this example embodiment, baler 100 is a smart baler with an integrated scale 110 with a digital signal output. The scale 110 is operatively connected to a processor 120. The scale 110 may be configured to weigh the material dynamically as it is being compressed for baling and/or to weigh a completed bale. When measuring the weight of a bale dynamically, the sensed weight changes as operations, such as compressing the material, are performed by the baler. The processor 120 is configured to analyze the dynamic signal from the scale 110 to determine when the bale is complete and/or when a bale should be or has been ejected by the baler. The processor may determine when a bale has exceeded a minimum weight threshold after being compressed and indicate that the bale should be completed. In some embodiments, the baler 100 is arranged to automatically complete the bale upon receiving a signal from the processor. It will be appreciated that the process of completing a bale typically involves wrapping the compressed material with wire, twine, or plastic wrap. In some embodiments, the baler 100 will automatically eject the bale once it has been completed. The dynamic weight measurement may be used to confirm that the bale has been properly ejected from the baler prior to beginning to form the next bale. Using a dynamic weight analysis provides a check on any potential human operator and reduces the possibility of a human operator creating inaccurate data whether intentionally or unintentionally.

In this exemplary embodiments, baler 100 also includes an integrated imaging device 130, such as a camera with or without a motion detector integrated with it. The camera 130 may be operably connected to a processor, such as processor 120. The camera 130 may be positioned to view material as it is loaded into the baler 100 and/or the completed bale as it is ejected from the baler. In some embodiments, the processor 120 may be connected to a network and configured to transmit and/or receive data over the network. In some embodiments, the processor 120 may be configured to perform computer vision analysis on image data received from the imaging device 130. In some embodiments, the processor 120 may be in communication with a computer vision processor, a database, and/or a server over the network. In some embodiments, the processor 120 or a computer vision processor in communication with processor 120 is arranged to determine a characteristic of the recyclable material based on image data received from imaging device 130. In some embodiments, the processor 120 may transmit baler data over the network. Baler data may include the weight of a bale, the volume of a bale, the type of material baled, the number of bales produced in a time period, the time material is initially loaded into the baler for a particular bale, the time a bale is completed, the time a bale is ejected, the location of the baler, and/or the identity of a human operator.

In the exemplary embodiment of FIG. 2, baler 100 includes a printer 140 for printing labels containing information related to a bale. Baler 100 may also include a control panel 150, an input device 160, and indicators 170.

In many embodiments, a smart baler is originally designed and manufactured to incorporate the described smart technologies. In some embodiments, a traditional baler may be retrofit with various monitors, scales, sensors, and other smart technologies in order to convert an existing baler into a smart baler. It will be understood that references to a smart baler may include smart balers which are originally designed and manufactured as such as well as traditional balers which have been retrofit with smart technologies such as, for example, those described in U.S. Patent Publication 2018/0056618, incorporated herein by reference.

As one of many possible examples, an alternative embodiment of the disclosed invention is a retro-fit of an existing traditional baler such as, for example, a Mil-Tek baler, compactor or crusher or any other existing baling device. A scale or other weighing device may be incorporated into an existing traditional baler. This scale can be operably connected to a processor which can automatically record the weight of the bale as well as the other data discussed throughout. Imaging devices such as a camera can also be operably connected to the processor. The camera can be configured to take pictures of the finished bale as well as the material being loaded into the baler in order to confirm that operator accurately identified the material being baled. In some embodiments, computer vision techniques may be used in order to determine the start time and completion time of each bale, the composition of each bale, and/or the other data discussed herein. The processor can be operably connected to a printer, such as a label printer, which prints labels displaying all of the necessary information for efficient tracking and management of each bale as well as efficient management of baling operations at the operator, location, region and/or enterprise level. The processor may be connected to a database, cloud or otherwise, and record all of the collected data in the database for further analysis as discussed throughout. The end result of a retro-fit traditional baler may be similar or identical in capabilities to a smart baler depending on the specific equipment incorporated and the arrangement of that equipment. It will be apparent that various distinct situations may require more or less incorporated equipment depending on the specific conditions in which the smart baler is deployed.

In some embodiments, a smart, digital, and/or connected scale may be utilized without necessarily being incorporated into a baler as discussed above. In such embodiments, smart technologies may be utilized to generate and/or gather data regarding at least one of the multiple material characteristics discussed herein, but the baler, compactor, and/or compressor, if such devices are utilized, may be traditional devices without integrated smart technologies. Many such embodiments will require a human operator to transfer material from a storage location or from a baler to the smart scale in order to generate weight and/or other data. Alternatively or additionally, a conveyor system, hoist system, or other automated transport system may be utilized to transfer material from an initial location to a smart scale in order to generate and collect the desired data.

Exemplary embodiments may include one or more networks. In some examples, the network may be one or more of a wireless network, a wired network or any combination of wireless network and wired network, and may be configured to connect a card reader and/or mobile device to a server. For example, the network may include one or more of a fiber optics network, a passive optical network, a cable network, an Internet network, a satellite network, a wireless LAN, a Global System for Mobile Communication (GSM), a Personal Communication Service (PCS), a Personal Area Network, Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g, Bluetooth, Near Field Communication (NFC), Radio Frequency Identification (RFID), Wi-Fi, and/or the like.

In addition, the network may include, without limitation, telephone lines, fiber optics, IEEE Ethernet 902.3, a wide area network (WAN), a wireless personal area network, a local area network (LAN), or a global network such as the Internet. In addition, the network may support an Internet network, a wireless communication network, a cellular network, or the like, or any combination thereof. The network may further include one network, or any number of the exemplary types of networks mentioned above, operating as a stand-alone network or in cooperation with each other. The network may utilize one or more protocols of one or more network elements to which they are communicatively coupled. The network may translate to or from other protocols to one or more protocols of network devices. Although the network is referred to as a single network, it should be appreciated that according to one or more embodiments, the network may comprise a plurality of interconnected networks, such as, for example, the Internet, a service provider's network, a cable television network, corporate networks, such as credit card association networks, and home networks.

FIG. 3 illustrates a densifier 200 according to an example embodiment. In this example embodiment, densifier 200 is equipped with an integrated scale 210 with a digital signal output. The scale 210 is operatively connected to a processor 220. The scale 210 may be configured to weigh the material dynamically as it is being densified and/or may be configured to weigh finished densified blocks. Densifiers are commonly used to process recyclable foams and/or polymers through a process of shredding and heating. Densifier 200 may be configured to extrude a densified block of recycled material. Densifiers are commonly used to reduce the size of three main types of foam: polystyrene, polyethylene, and polypropylene, but may be used to condense and/or densify many other materials as is known in the art.

In the exemplary embodiments, densifier 200 also includes an integrated imaging device 230, such as a camera with or without a motion sensor integrated with it. The camera 230 may be operably connected to a processor, such as processor 220. The camera 230 may be positioned to view material as it is loaded into the densifier 200 and/or the densified block as it is ejected from the densifier. In some embodiments, the processor 220 may be connected to a network and configured to transmit and/or receive data over the network. In some embodiments, the processor 220 may be configured to perform computer vision analysis on image data received from the imaging device 230. In some embodiments, the processor 220 may be in communication with a computer vision processor, a database, and/or a server over the network. In some embodiments, the processor 220 or a computer vision processor in communication with processor 220 is arranged to determine a characteristic of the recyclable material being densified based on image data received from imaging device 230. In some embodiments, the processor 220 may transmit densifier data over the network. Densifier data may include the weight of a block, the volume of a block, the type of material densified, the number of blocks produced in a time period, the time material is initially loaded into the densifier for a particular block, the time a block is ejected, the location of the densifier, and/or the identity of a human operator.

In the exemplary embodiment of FIG. 3, densifier 200 includes a printer 240 for printing labels containing information related to a densified block. Densifier 200 may also include a control panel 250, and an input device 260.

FIG. 4 illustrates a container with fullness sensor 300 according to an example embodiment. The container may be any container suitable for containing waste materials, such as recyclable materials. In this example embodiment, fullness sensor 300 is operatively connected to a processor 320 and configured to monitor the amount of material within the container 310.

Fullness sensor 300 may monitor the absolute amount of material in container 310 or may monitor the relative fullness of the contain 310. In some embodiments fullness sensor 300 may be an image based sensor or an ultra-sonic sensor. In the exemplary embodiments, fullness sensor 300 includes an imaging device 330 with or without a motion sensor integrated with it. The imaging device 330 may be operably connected to a processor, such as processor 320. The imaging device 330 may be positioned to view material within the container 310. In some embodiments, the processor 320 may be connected to a network and configured to transmit and/or receive data over the network. In some embodiments, the processor 320 may be configured to perform computer vision analysis on image data received from the imaging device 330. In some embodiments, the processor 320 may be in communication with a computer vision processor, a database, and/or a server over the network. In some embodiments, the processor 320 or a computer vision processor in communication with processor 320 is arranged to determine a characteristic of the recyclable material within the container 310 based on image data received from imaging device 330. In some embodiments, the processor 320 may transmit data relating to the fullness of container 310 over the network. This data may be useful in scheduling recycling operations, pick-up and/or removal of the material within the container 310.

Embodiments of the disclosed system are arranged to provide increased visibility into a waste handling process. By centralizing much or all of this data in a database(s), such as, for example, a remote or cloud database, a coordinated and detailed analysis of all waste and/or recyclable materials for a given location and/or enterprise may be created and maintained with relatively little human input. Collected data may also be accessible at any time and/or from any location by allowing a user to log into the database remotely. The described approach to managing recyclable materials allows for the identification of inefficiencies at both individual baling stations as well as enterprise wide operations. In some embodiments of the disclosed system, this data is initially collected using disclosed embodiments of a baler with integrated or associated sensors such as a smart baler.

Some embodiments of the disclosed systems include an imaging device, such as a scanner, camera, video camera, and/or hyperspectral camera operably connected to a processor. An imaging device may be positioned to view material, for example, as it is entering a facility, while it is stored, when it is fed into a baler or densifier, as the material is being baled, as the baled or densified material is exiting a baler or densifier, as the bale or block of material is stored, and/or as the bale and/or block of material is loaded onto a truck or otherwise removed from a facility.

In some embodiments, a processor may be configured to receive image data from an imaging device to determine a characteristic of the waste material and/or recyclable material. This characteristic may be the composition and/or type of the recyclable material, the volume of the material, the weight of the material, the components of the material, and/or whether the material is recyclable. This information may be used to label a bale or block which is formed from the recyclable material or to confirm a manual entry input by an operator is accurate.

In some embodiments, a processor may be configured to monitor the total quantity of a given material(s) that has been baled, densified, or otherwise processed in a given time period. This information may be used, along with information related to the total amount of material received at a particular location to determine the overall portion of recyclable material that has been captured for baling or recycling.

Some disclosed embodiments use imaging devices to monitor and/or quantize the waste materials, including recyclable materials that enter a facility over a given time and how those materials are processed prior to being transported away from a facility. The visual data and/or image data captured by the imaging devices may be analyzed using a processor. The processor may be integral to the imaging device or remote. The automated and/or processor-based interpretation of image data may be known as computer vision. In some embodiments, the disclosed processor is or is operably connected to a computer vision processor. It will be appreciated that the processor may be configured to execute computer vision applications, programs, software, and/or techniques which may be stored on local and/or remote servers and/or memory.

The process of detection characteristics of the materials may include one or a plurality of computer vision and/or feature detection algorithms including, but not limited to a histogram of oriented gradients (HOG), integral channel features (ICF), aggregated channel features (ACF), and/or deformable part models (DPM). In some embodiments, tracking algorithms may also be utilized including, but not limited to Kalman filters, particle filters, and/or Markov chain Monte Carlo (MCMC) tracking approaches. Different algorithms may provide unique performance characteristics in terms of accurately determining material characteristics. Each computer vision and/or feature detection approach may also provide differing performance characteristics based on the lighting and/or other visual characteristics of a particular deployment.

Some embodiments of the disclosed systems incorporate multiple technologies into a unified process for receiving, tracking, and/or identifying material as it enters a facility. The process may also involve separating recyclable materials from non-recyclable materials, baling the recyclable material, baling the non-recyclable material, and/or otherwise preparing the materials to be removed from the facility. Potential methods of preparing material for removal include, but are not limited to compressing, dissolving, melting, shrinking, densifying, wrapping, boxing, caging, and/or palletizing material. Data may be generated and/or collected during each step in this process either manually or automatically. As discussed, imaging devices and computer vision techniques may be used to identify and/or quantify incoming material. Scales which are operably connected to a processor may be used to determine and automatically record the amount of material received. A processor or server in communication with a database may determine what portion of incoming material is recyclable. This information may also be collected using RFID or other near field communication labels or may be manually determined and entered into a terminal and/or database by an operator.

Data may be generated and/or collected as the recyclable and/or non-recyclable material is being baled or otherwise prepared for removal. Such data may include, but is not limited to, bale identification numbers which may correspond with the type of material, weight of material, volume of material, date and/or time the material was baled, identification of what shipment and/or package the material was part of when the material was initially received, the origin of the material, and/or information relating to the pricing or other financial aspects of the material. Any and/or all of this data may be communicated between a processor located at the facility and a remote server or database which stores, collects, and/or analyzes such information. Databases, processors, and servers used for collecting, generating, storing, and/or analyzing data may be located at the facility but will more commonly be located remotely.

The disclosed system may monitor the rate at which material is being prepared for removal and the quantity of baled or prepared material already being stored. Using this information, along with known information such as how much material may be removed during a single pick-up, the system may generate an expected pick-up time for the material. This process may utilize information including but not limited to the current amount of material collected, the available storage space for materials, the cost of pick-up and/or delivery to one or multiple locations, the anticipated price of the material at one or multiple locations, the time required to load material for pick up, the scheduling of operations at the facility, the anticipated lead time between sending a pick-up request and the pick-up occurring, and/or a wide variety of financial information relating to the material.

It will be appreciated that the disclosed system has generally been described with respect to a single facility, but many embodiments of the disclosed system may be related to multiple facilities which may be governed as an enterprise. In such embodiments, data may be collected and/or generated which compares multiple facilities relative to each other in order to determine best practices and/or increase the desired performance of each facility and/or the enterprise as a whole. It will also be appreciated that in such embodiments, the various facilities may serve different purposes from one another. This creates the possibility of, for example, transporting material from one facility to another with additional storage space prior to scheduling a pick-up of the material to be monetized or otherwise removed. This may allow for larger single shipments of material which may allow for greater economies of scale including delivering material to more remote locations which may have a more desirable price for a given material.

Embodiments of the disclosed system may comprise a database in which information relating to incoming material is entered, either manually or automatically. In certain embodiments, a human operator may input the quantity and type of materials that are entering a facility into the database. In other embodiments, this information may be automatically determined using computer vision techniques and an imaging device, such as a camera, positioned to view incoming material as it enters the facility. This information may be used to determine the total amount of recyclable materials that have entered a facility in order to determine the CPR of the facility. In some embodiments, an imaging device may be positioned to view material as it is entering the facility. A processor may be operably connected to the imaging device and configured to receive image data. The processor may use computer vision techniques to automatically determine characteristics of the incoming material such as the type of material, volume of material, weight of material, components of the material, and/or the portion of the incoming material which is recyclable.

The disclosed processor and/or database may be provided with information regarding the specific facility in which the disclosed system is operating. If a particular facility has a specified amount of storage space, the processor may be configured to determine the rate at which baled and/or recyclable material is accumulating and determine approximately when the storage space will be full. Based on these calculations, the processor may be configured to schedule a pick-up at the appropriate time. This feature may be utilized in order to avoid storing excessive amounts of material and also to avoid paying excessing costs associated with picking up materials.

Preferred embodiments of the disclosed system generate a single index capture percentage rate using the above described technologies including, but not limited to scales, weight sensors, cameras, video cameras, bar code, QR scanners, RFID scanners, and/or near field communication readers which may be operably connected to a processor. The processor gathers this information in order to determine what portion of recyclable material that is entering a given facility is being recycled and/or monetized. This allows an operator to quickly determine the overall efficiency of its waste management processes. This data may be reported to an operator in real-time or as a longer term report covering a pre-determined time frame such as hourly, daily, weekly, monthly, and/or annually.

In some preferred embodiments, an audit database is utilized in order to check, determine, and/or confirm the quality of the collected, gathered, and/or generated data. Data collected in the audit database may be utilized in order to check the validity of the raw data collected including any raw data which is manually entered by a human operator or is dependent on data generated by a human operator. In certain embodiments, only automatically generated data may be collected in a particular database. That automatically collected data may then be analyzed in order to reverse engineer expected values for information which may has been entered by a human operator or is dependent on information entered by a human operator. This type of data audit may be used in order to determine the accuracy of the human data entered. These datasets may be visualized or otherwise compared in order to clarify any potential sources of inaccurate data and/or to generate a confidence indicator regarding the generated and/or collected data. In general, it is preferable to collect and/or generate as much information as possible automatically and without the input of a human operator. This provides a check on data entered by a human operators as discussed and helps to avoid potential time delays and human error.

One potential exemplary embodiment of the disclosed data audit system involves checking for operator error as follows: Operator 1 enters his personal identification into a smart baler that he will be operating and enters an identifier for Material 1, the type of material that he will be handling. Operator 1 proceeds to work a shift. After Operator 1 has completed his shift, Operator 2 proceeds to use the same baler and handles Material 1 for the first half of his shift and Material 2 for the second half of his shift. Due to human error, Operator 2 may forget to input his own personal identification, and thereby fail to inform the baler and associated databases when he is working as opposed to Operator 1. In this instance, there will be an inaccurate record that shows Operator 1 working two consecutive shifts and Operator 2 not working at all rather than showing Operator 1 working a single shift and Operator 2 working the next shift.

Similarly, Operator 2 may forget to enter a new material identification when he stops baling Material 1 and starts to bale Material 2. In this instance, there will be a false record which over-reports the amount of Material 1 baled and under-reports the amount of Material 2 baled. It will be appreciated that these are merely examples and that there are numerous other opportunities for human operator error to create an inaccurate record.

In some embodiments, an auditing system may be used to cross-check shifts worked by each operator against an planned work schedule. In this case, the auditing system may identify the inconsistency between the planned working schedule and the reported working schedule. Once an inconsistency between multiple sources of data has been identified, the originally entered data may be maintained as raw data and an updated corresponding record showing the expected data may be generated as auditing data. In some embodiments, the system may present this data to a manager or other personnel for further investigation.

In some embodiments of the disclosed systems an imaging device is operably connected to a processor. In these embodiments, the processor may be configured to determine the identity of an operator based on facial recognition or computer vision techniques. The processor may also or alternatively be configured to identify the material being processed using computer vision techniques and the visual data transferred from the imaging device to the processor. In this exemplary embodiment, there will be a record, generated by the imaging device and processor, of how many bales of each material were baled at a given time and place. In the instance in which Operator 2 stops baling Material 1 and begins to bale Material 2, but fails to enter the new identification code for Material 2, there will be conflicting reports regarding how much of Materials 1 and 2 were baled during that shift. In this situation, similar to the situation described above, the audit system may cross reference the various reports and identify the conflicting information. The underlying information may be maintained, but the auditing system may visualize or otherwise highlight the conflicting data for further investigation. In some embodiments, the system may be configured to generate a new record which gives preference to automatically generated information which is less susceptible to human error. In certain embodiments, there may be multiple sources of information which confirm the fact that Operator 2 forgot to identify that he had stopped baling Material 1 and started to bale Material 2. In such instances, the system may generate an updated report. In some embodiments, this update report will highlight the underlying conflict of information. In certain embodiments, the system will only present the revised or updated information determined to be the most accurate. The system may be configured to present conflicting information based on a pre-determined confidence threshold or based on the ratio of data sources that agree relative to the number of conflicting data sources. Known computer tally techniques or other methods for determining the confidence associated with a data set may be utilized when a conflict in data is detected.

Disclosed embodiments will utilize at least one of many potential performance indicators. Capture Percentage Rate (CPR) is typically equal to R/(W+R) where R is the weight of total recyclables and W is the weight of total waste (where waste could be landfilled waste or incinerated waste). Metrics other than weight may be utilized in order to compare the ratio of recyclable materials to the total of recyclables plus waste materials. Other such metrics include, but are not limited to, volume, bales, containers full, and/or truckloads and the like.

Another potential KPI may be Income Opportunity. This is a measurement of revenue plus cost savings that a facility may realize. This, and other KPIs may be calculated for individual facilities, or by region, or enterprise.

In a non-limiting example of income opportunity, Company A has a maximum possible CPR of 98% (meaning 2% of the total incoming material is non-recyclable and the remaining 98% could be monetized), but is only realizing a CPR of 50%. In this exemplary circumstance, there is a dollar amount related to the potential increase in CPR related to increased revenue generation from monetizing recyclables. Since the finite total amount of material is defined as non-recyclable waste “W”+recyclable material “R”, as R increases, W decreases. Organizations typically must pay to have non-recyclable waste removed, therefore W is typically associated with a cost. When the W amount decreases, there will be a dollar amount related to this W reduction which may be interpreted as savings. This may be equally interpreted as income in the form of expense reduction. In some cases, there may be additional savings from reduced sizing of waste equipment and/or labor savings. In addition to the savings from reducing W, there may be an increase in direct revenue associated with the increasing R value. By capturing and monetizing a greater portion of recyclable materials, a company may see a direct increase in revenue in addition to reduced costs. The total amount of unrealized savings and revenue is referred to as the income opportunity. There are numerous potential components which make up the total income opportunity. In some embodiments, these components and/or the complete income opportunity associated with increasing a company's CPR may be reported, visualized, considered, and/or utilized as performance metrics either individually or in combination with other metrics.

In this example, as more data is collected or otherwise becomes available and as more actions utilizing that data are implemented, CPR will gradually increase from the initial 50% towards the theorized maximum of 98% and waste cost removal will be decreased As a company or facility approaches the maximum potential CPR, the income opportunity will decrease.

Additional performance indicators which may be utilized include, but are not limited to, Total Recyclable Revenue, Total Recyclable Weight, Total Waste Weight, and Total Environmental Impact which may include the number of cubic yards of landfill space saved, the amount of carbon dioxide reduced, the number of trees saved, the number of barrels of oil saved, the number of homes powered, and/or the BTUs of energy saved.

In addition to imaging devices, balers, and scales, several other sources of information may be utilized in order to collect information. Data may be gathered automatically or entered manually by a human operator. This data includes, but is not limited to, the weight or volume of waste landfilled or incinerated; the weight or volume of recyclables as captured by balers, densifiers, and/or containers; the number of wooden pallets, plastic pallets, and/or other containers utilized or collected; revenue related to monetized recyclables; savings related to waste reduction; cost savings related to reduced labor and/or the reduced frequency of waste disposal pickups and/or drop-offs.

The disclosed system, methods, equipment, and processes allow the user to visualize, simulate, and/or take action to make improvements in the waste management process. Disclosed systems may also allow for identification of opportunities which have not yet been realized and the necessary actions to be taken in order to realize any opportunities found.

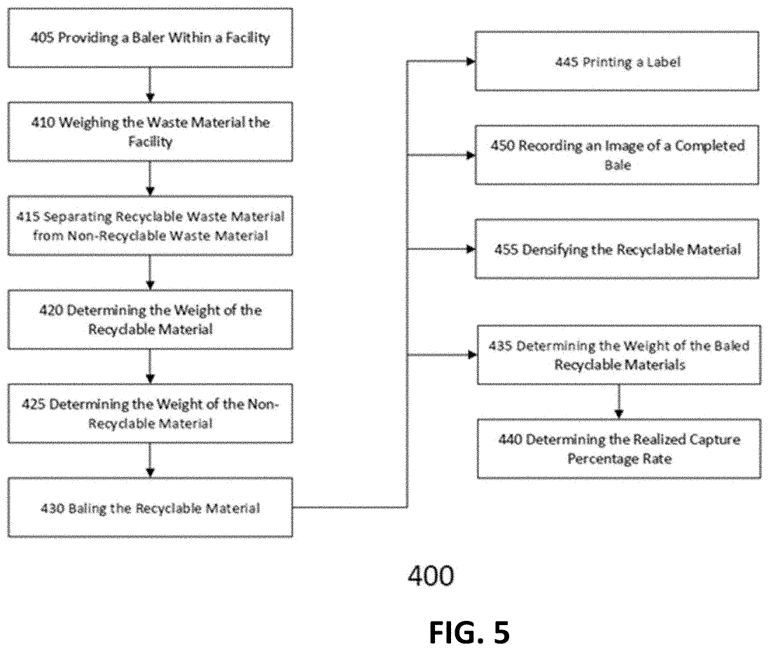

FIG. 5 shows method 400 of recycling waste materials using according to an exemplary embodiment. Method 400 includes, at step 405, providing a baler within a facility. The baler comprises a scale with a digital signal output and is communicatively coupled to a processor. In this exemplary embodiments, the processor is configured to record the type of material baled, the number of bales produced in a time period, and the weight of each bale. Step 410 includes weighing or otherwise quantizing the amount of waste material that enters a facility. It will be appreciated that the waste material entering the facility may include recyclable materials and/or non-recyclable materials. Once the total amount of waste materials entering the facility has been weighed or quantized, at step 415, the recyclable materials are separated from the non-recyclable materials. The recyclable and non-recyclable materials may be stored in separate containers be processed immediately after being separated. Step 420 includes determining the weight of the recyclable material. Step 425 includes determining the weight of the non-recyclable materials. It will be appreciated that the weight of the recyclables, non-recyclables, or total waste materials may be determined without direct measurement if the other two quantities are known. At step 430, the recyclable materials are baled using a baler. In some embodiments, the recyclable materials or a portion of the recyclable materials may be densified, wrapped, or otherwise processed in addition to or instead of baling the materials. At step 435, the weight of the baled or otherwise processed recyclable waste material is determined. It will be appreciated that not all of the recyclable materials that enter a facility may be separated from the non-recyclable materials and/or processed. In most circumstances, at least some recyclable material will not be processed or later monetized. Step 440 includes comparing the weight of the baled or otherwise processed recyclable materials to the total weight of the recyclable waste material that entered the facility. This comparison is used to determine the realized capture percentage rate or the percent of the total recyclable material that enters a facility that is processed. In most embodiments, recyclable materials may be monetized after they have been processed.

In some embodiments, exemplary method 400 optionally includes, at step 445, printing a label comprising bale information; at step 450, recording an image of a completed bale using an imaging device; and/or at step 455 densifying the recyclable material.

Disclosed embodiments relate to a system for recycling material comprising: a baler within a facility, the baler communicatively connected to a central server, wherein the baler is configured to transmit baler data over a network, and wherein the server is configured to receive baler data; and a first imaging device positioned to view a recyclable material within the facility, the first imaging device operably connected to a processor, the processor arranged to determine a characteristic of the recyclable material based on image data received from the first imaging device. In some embodiments, the baler data comprises: weight of a bale, volume of a bale, type of material, or number of bales produced in a time period. Some embodiments, further comprise a second imaging device positioned to view an incoming material, the second imaging device operably connected to a processor, the processor communicatively coupled to a network, wherein the processor is arranged to determine a characteristic of the incoming material based on image data received from the second imaging device. In some embodiments, the characteristic of the incoming material comprises: the type of the incoming material, volume of the incoming material, weight of the incoming material, components of the incoming material, or whether the incoming material is recyclable. In some embodiments, the processor is configured to determine the quantity of the incoming material, the portion of the of the incoming material that is recyclable, and the portion of the incoming material that is balable by the baler, and wherein the processor transmits this data over a network to the central server. In some embodiments, the processor determines a characteristic of the recyclable material using computer vision techniques; the data indicating the quantity of incoming material, the portion of the of the incoming material that is recyclable, and the portion of the incoming recyclable material that is balable is recorded in a database; the central server applies a predictive model to the data recorded in the database and the baler data to determine a schedule for transporting baled material out of the facility; the central server sends a notification to a transporter, the notification comprising scheduling information; the central server is determines a capture percentage rate from the data recorded in the database and the baler data; and/or the image data from the first and second imaging devices, the quantity of the incoming material, the portion of the of the incoming material that is recyclable, the portion of the incoming recyclable material that is balable, and the baler data are displayed in a control center. Some embodiments further comprise a densifier, the densifier communicatively connected to the central server and configured to transmit densifier data over a network; a third imaging device positioned to view a recyclable material as it is loaded into the densifier, the third imaging device operably connected to a processor, the processor configured to determine a characteristic of the recyclable material based on image data received from the third imaging device; and a fullness sensor positioned to monitor the fullness of a container, the fullness sensor communicatively connected to the central server.

Some disclosed embodiments relate to a method of recycling material comprising: providing a baler within a facility, wherein the baler comprises a scale with a digital signal output and is communicatively coupled to a processor, the processor configured to record the type of material baled, the number of bales produced in a time period, and the weight of each bale; weighing waste material that enters the facility, wherein the waste material comprises recyclable waste material and non-recyclable waste material; separating recyclable waste material from non-recyclable waste material; determining the weight of the recyclable waste material; determining the weight of the non-recyclable waste material; baling the recyclable waste material; determining the weight of the baled recyclable waste material; and comparing the weight of the baled recyclable waste material to the weight of the total recyclable waste material that enters the facility to determine the realized capture percentage rate. In some embodiments, the baler is configured to dynamically weight a material as it is loaded into the baler and determine when a bale is complete; the baler prints a label comprising bale information upon determining a bale is complete; the bale information comprises the weight of the bale, volume of the bale, type of material baled, or time the bale was completed; and/or the baler comprises an imaging device and records an images of a completed bale. Some embodiments further comprise the step of densifying the recyclable waste material into a block using a foam densifier within the facility, wherein the foam densifier comprises a scale with a digital signal output and is communicatively coupled to a processor, the processor configured to record the type of material densified, the number of blocks produced in a time period, and the weight of each block.

Throughout the specification, reference is made to balers and smart balers. It will be understood that baler and/or smart baler may include any device which compresses a material into a more compact form. It will also be understood that a baler operatively connected to a digital scale will be considered a smart baler. While a smart baler may include many other sensors, processor, or components, these are not required for a baler to be considered a smart baler.

Throughout the specification, reference is made to a recyclable material or materials. Many materials may be recycled or disposed of other than in a landfill or incinerator. It will be understood that any material which may be monetized after its initial use may be considered a recyclable material.

FIG. 6 illustrates an example computing environment in which example embodiments and aspects may be implemented. The illustrated computing device may comprise all or part of a cloud-based network and/or a processor associated with the image capture device described herein. As used herein, “computer,” “processor,” and “computing device” may refer to a singular device and/or may refer to a plurality of “computers,” “processors,” and “computing devices.” The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, cloud-based systems, microprocessor-based systems, network personal computers (PCs), minicomputers, mainframe computers, embedded systems, distributed computing environments that include any of the above systems or devices, and the like. The computing environment may include a cloud-based computing environment.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an example system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
a receptacle with at least one opening to deposit one or more predetermined types of material;
a camera positioned to view the at least one opening wherein the camera is configured to transmit and receive signals and data;
a detector operably connected to the camera and configured to communicate a signal to the camera to take a photo of the at least one opening upon detection of an event indicating a deposit being made to the receptacle; and
a processor operably linked to the camera wherein the processor is configured to receive a photo from the camera of a deposit being made and wherein the processor is configured to detect from the photo when the deposit is not or does not contain any of the one or more predetermined types of material.

2. The system of claim 1, wherein the detector comprises one or more of a motion detector, an acoustic or sound sensor, a pressure sensor, a switch on a cover or door of the at least one opening or attached to or associated with the receptacle, or a smart tag or RFID tag which signals the camera to start the recording process.

3. The system of claim 2, wherein the smart tag or RFID tag is attached to the material or a person or equipment, carrying the material, and the detector comprises a smart tag and/or RFID reader.

4. The system of claim 2, wherein the motion detector comprises one or more of passive infrared sensor, a microwave sensor, or a dual tech or hybrid sensor.

5. The system of claim 1 wherein the processor is further configured to provide a notification when a deposit is not or does not contain any of the one or more predetermined types of material.

6. The system of claim 1 further comprising a memory, wherein the processor is further configured to store the photo from the camera in the memory.

7. The system of claim 1 wherein the processor is further configured to determine from a plurality of photos of material deposited into the receptacle over a period of time a volume of total deposits that are not the one or more predetermined types of material over the period of time.

8. The system of claim 1 wherein the processor is further configured to determine from a plurality of photos of material deposited in the receptacle over a period of time a weight of total deposits that are not the one or more predetermined types of material over the period of time.

9. The system of claim 1 wherein the processor is further configured to detect when the deposit is the one or more predetermined types of material from the photo and wherein the processor is further configured to determine a volume of total deposits from a plurality of photos of material deposited in the receptacle over a period of time that are the one or more predetermined types of material over the period of time.

10. The system of claim 1 wherein the processor is further configured to detect from the photo when the deposit is the one or more predetermined types of material from the photo and wherein the processor is further configured to determine a weight of total deposits from a plurality of photos of material deposited in the receptacle over a period of time that are the one or more predetermined types of material over the period of time.

11. The system of claim 1 wherein the processor is further configured to provide a notification when a deposit is or contains any of the one or more predetermined types of material.

12. The system of claim 1 wherein the processor is further configured to sum from a number of deposits of material into the receptacle that are not or do not contain any of the one or more predetermined types of material over a period of time.

13. The system of claim 1 wherein the processor is further configured to provide a ratio of deposits that are not or do not contain any of the one or more predetermined types of material to the total deposits.

14. The system of claim 1 wherein the one or more predetermined types of material are selected from the group consisting of cardboard, plastic, foam, bottles, and mixtures thereof.

15. The system of claim 1 wherein the processor configured to detect from the photo when the deposit is not or des not contain any or the one or more predetermined types of material has an accuracy rate of at least about 90% based upon the total number of deposits to fill the receptacle.

16. The system of claim 1 wherein the processor configured to detect from the photo when the deposit is not or does not contain any of the one or more predetermined types of material has an accuracy rate of at least about 95% based upon the total number of deposits to fill the receptacle.

17. The system of claim 1 wherein the processor configured to detect from the photo when the deposit is not or does not contain any of the one or more predetermined types of material employs object detection.

18. The system of claim 17 wherein the object detection employs an other region proposal classification network (RCNN) a fully convolutional neural network (FONT), a you only look once network (YOLO), or a combination thereof.

19. The system of claim 17 wherein the object detection employs a you only look once network) (YOLO).

20. The system of claim 1 wherein the camera captures more than one photo of the at least one opening upon detection of the event indicating a deposit being made to the receptacle.

21. The system of claim 1 wherein the camera captures a video of the at least one opening upon detection of the event indicating a deposit being made to the receptacle

22. The system of claim 1 wherein the processor is operably connected to a cloud database configured to receive the photo of the at least one opening upon detection of the event indicating a deposit being made to the receptacle.

23. The system of claim 1 wherein the processor is operably connected to a cloud database configured to receive a video of the at least one opening upon detection of the event indicating a deposit being made to the receptacle.
